(19) United States
(12) Patent Application Publication
(10) Pub. No.: US 2012/0204898 A1
(43) Pub. Date: Aug. 16, 2012

(54) All in One

(76) Inventor: Reanna L. Haley, Kaneohe, HI (US)

(21) Appl. No.: 13/371,957

(22) Filed: Feb. 13, 2012

Related U.S. Application Data
(60) Provisional application No. 61/443,357, filed on Feb. 16, 2011.

(51) Int. Cl. A46B 15/00; A61C 15/04; A61C 17/00; A46B 11/00

(52) U.S. Cl. 132/309

(57) ABSTRACT

An architecture is presented that provides a toothbrush device designed for consumer use, when traveling or away from home. The toothbrush device comprises a handle comprising a first end and a second end, and a brush head and a flossing device. The brush head is secured to the first end of the handle, and the flossing device is secured to the second end of the handle. Furthermore, the toothbrush device can be used as a single use device or a multiple use device. The single use toothbrush device comprises a predetermined amount of toothpaste in the center of the brush head, and a predetermined amount of floss attached to the flossing device. The multiple use toothbrush device comprises a hollow, interior cavity comprising a predetermined amount of toothpaste to be dispensed from the brush head via an actuator, and a coil of floss that is dispensed via the flossing device.

### CROSS-REFERENCE

This application claims priority from Provisional Patent Application Ser. No. 61/443,357 filed Feb. 16, 2011.

### BACKGROUND

When traveling or away from home, many individuals desire to maintain good dental hygiene including the ability to brush their teeth. Carrying a toothbrush along with a cumbersome tube of toothpaste and a container of floss can be bulky and difficult. Furthermore, many toiletry bags do not have a vast amount of space for users to store such bulky items, and many bathroom cabinets and sinks are overcrowded with oral hygiene products. Additionally, many users forget to floss. Typically, flossing is a separate task, and thus often overlooked. Accordingly, proper brushing and flossing is often times neglected due to time restraints during meals either at work, school or during recreational activities. It is also well known that without proper dental hygiene, individuals can contract gum disease and other ailments relating to oral hygiene. An effective solution is necessary.

There is a need for an improved disposable toothbrush which provides for complete dental care in a singular unit. The present invention discloses a toothbrush device that comprises a handle, a brush head, and a flossing device. The handle comprises a first end and a second end, wherein the brush head is secured to the first end of the handle, and the flossing device is secured to the second end of the handle. Thus, the toothbrush device provides users with an easy and efficient device for tending to their oral hygiene needs without having to carry multiple items. This device can assist users in brushing and flossing at home, work, school or while traveling. It also allows users to simplify their toiletry bag and bathroom counter by eliminating clutter and encourages users to floss by providing an accessible flossing tool on their toothbrush. Users will appreciate the convenience and practicality that this product provides.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a toothbrush device designed for consumer use, when traveling or away from home. The device is comprised of a toothbrush that includes toothpaste and a flossing device in one singular unit. Specifically, the toothbrush device comprises a handle comprising a first end and a second end. The handle being a tubular shaped handle. The toothbrush device also comprises a brush head and a flossing device, wherein the brush head is secured to the first end of the handle, and the flossing device is secured to the second end of the handle. The brush head comprises bristles mounted on the brush head, which extend outwardly from, and substantially perpendicular to, the handle.

Furthermore in the preferred embodiment of the present invention, the toothbrush device can be used as a single use device or a multiple use device. The single use toothbrush device is smaller than the multiple use toothbrush device and comprises a predetermined amount of toothpaste in the center of the brush head, and a predetermined amount of floss attached to the flossing device. The multiple use toothbrush device is larger than the single use toothbrush device and comprises a hollow, interior cavity comprising a predetermined amount of toothpaste to be dispensed from the brush head via an actuator. The multiple use toothbrush device also comprises a coil of floss that is dispensed via the flossing device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a toothbrush device in accordance with the disclosed architecture.

FIGS. 2 and 2A illustrate a perspective view of a single use toothbrush device in accordance with the disclosed architecture.

FIG. 3 illustrates a perspective view of a multiple use toothbrush device in accordance with the disclosed architecture.

FIG. 4 illustrates a perspective (cut away) view of the handle of the multiple use toothbrush device in accordance with the disclosed architecture.

FIG. 5 illustrates a perspective view of the flossing device of the multiple use toothbrush device in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a toothbrush device designed for consumer use, when traveling or away from home. The device is comprised of a toothbrush that includes toothpaste and a flossing device in one singular unit. The toothbrush device allows users to brush and floss with ease without having to carry multiple items. Specifically, the toothbrush device assists users in brushing and flossing at home, work, school, while traveling, as well as assisting users in the military. The toothbrush device can be a one-time or single use toothbrush device or an extended or multiple use toothbrush device.

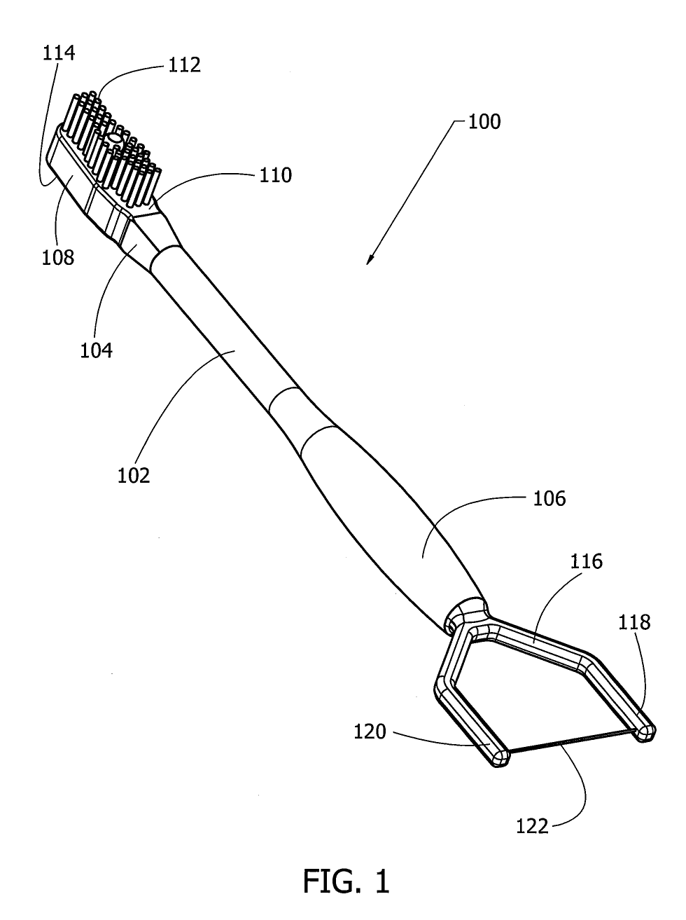

Referring initially to the drawings, FIG. 1 illustrates a toothbrush device 100 designed for consumer use, when traveling or away from home. The toothbrush device 100 comprises a handle 102 comprising a first end 104 and a second end 106. The handle 102 being a tubular shaped handle. However any other suitable shape can be used such as rectangular, oval, etc. without affecting the overall concept of the invention. The handle 102 can also be shaped to be a narrower on one or both ends (104 and 106) such that the handle 102 forms a neck (not shown), without affecting the overall concept of the invention. The handle 102 would generally be constructed of plastic, such as acrylonitrile butadiene styrene (ABS) or polyvinyl chloride (PVC), though any other suitable material may be used to manufacture the handle 102 as is known in the art without affecting the overall concept of the invention. The handle 102 is approximately between ¼ and 1 inches in diameter, and approximately between 3 and 8 inches long.

The toothbrush device 100 further comprises a brush head 108. The brush head 108 has the appearance of a typically constructed toothbrush head, having a first surface 110 upon which bristles 112 are mounted, and an opposing surface 114. The brush head 108 is secured to the first end 104 of the handle 102 via any typical fastening means such as gluing, welding, etc. However, the handle 102 and the brush head 108 can also be an integral unit, without affecting the overall concept of the invention. The bristles 112 mounted on the first surface 100 of the brush head 108 extend outwardly from and substantially perpendicular to the handle 102. However, the bristles 112 can extend in any other suitable orientation, such as slanted, straight, etc. without affecting the overall concept of the invention. Further, some of the bristles 112 can be straight and some of the bristles 112 can be slanted in orientation when positioned on the first surface 110 of the brush head 108. The length of the various bristles 112 may also vary relative to one another, as is known in the art.

Additionally, the toothbrush device 100 comprises a flossing device 116. The flossing device 116 is secured to the second end 106 of the handle 102 via any typical fastening means such as gluing, welding, etc. However, the handle 102 and the flossing device 116 can also be an integral unit, without affecting the overall concept of the invention. The flossing device 116 comprises a first end 118 and a second end 120, with floss 122 being attached to the first and second ends (118 and 120) of the flossing device 116 to provide a taunt, horizontal string for flossing.

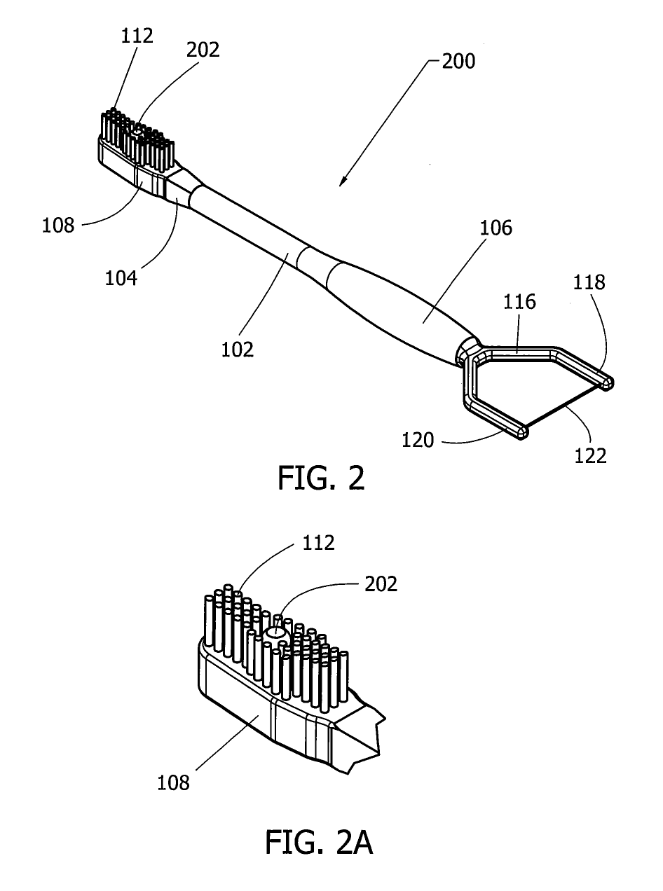

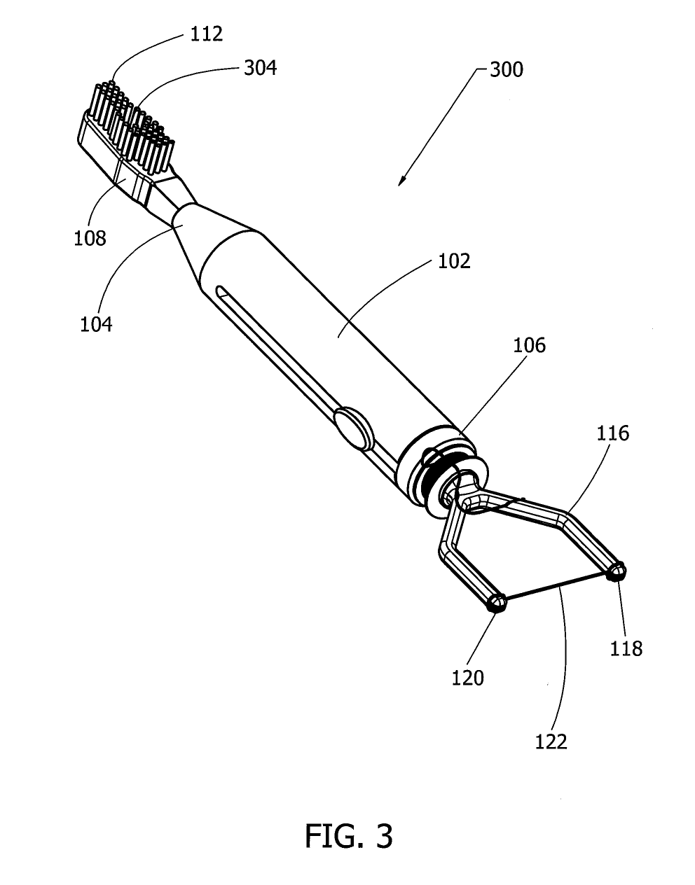

Furthermore, the toothbrush device 100 can be used as a single use device or a multiple use device. As shown in FIG. 2, the single use toothbrush device 200 is smaller than the multiple use toothbrush device (shown in FIG. 3). The single use toothbrush device 200 is approximately between ¼ and ⅓ inches in diameter, and approximately between ¼ and 4/3 inches high, and approximately between 3 and 4 inches long. The single use toothbrush device 200 comprises a handle 102, a brush head 108, and a flossing device 116. The handle 102 comprises a first end 104 and a second end 106, wherein the brush head 108 is secured to the first end 104 of the handle 102, and the flossing device 116 is secured to the second end 106 of the handle 102, or vice versa.

The brush head 108 comprises bristles 112 mounted on the brush head 108, the bristles 112 extend outwardly from and substantially perpendicular to the handle 102. Furthermore as shown in FIG. 2A, the brush head 108 comprises a predetermined amount of toothpaste 202 in the center of the brush head 108, between the bristles 112. The predetermined amount of toothpaste 202 is typically dried or gel-like toothpaste, or any other dentifrice of suitable consistency can be used without affecting the overall concept of the invention. Further, the flossing device 116 comprises a first end 118 and a second end 120, wherein the flossing device 116 comprises a predetermined amount of floss 122 attached to the first end 118 and the second end 120 of the flossing device 116 to provide a taunt, horizontal string for flossing. Once a user uses the predetermined amount of toothpaste 202 and the predetermined amount of floss 122, the single use toothbrush device 200 can be disposed of.

FIG. 3 illustrates the multiple use toothbrush device 300. The multiple use toothbrush device 300 is larger than the single use toothbrush device (shown in FIGS. 2 and 2A). The multiple use toothbrush device 300 is approximately between ½ and 1 inches in diameter, and approximately between 1 and 2 inches high, and approximately between 6 and 8 inches long. The multiple use toothbrush device 300 comprises a handle 102, a brush head 108, and a flossing device 116, as the single use toothbrush device does. The handle 102 comprises a first end 104 and a second end 106, wherein the brush head 108 is secured to the first end 104 of the handle 102, and the flossing device 116 is secured to the second end 106 of the handle 102, or vice versa. For example, the flossing device 116 may be secured to the first end 104 of the handle 102, and the brush head 108 may be secured to the second end 106 of the handle 102.

The brush head 108 comprises bristles 112 mounted on the brush head 108, the bristles 112 extend outwardly from and substantially perpendicular to the handle 102. Furthermore, the handle 102 comprises a hollow, interior cavity (not shown) comprising a predetermined amount of toothpaste (not shown). The hollow, interior cavity extends along a longitudinal axis and preferably extends from the first end 104 of the handle 102 to the second end 106 of the handle 102. The hollow, interior cavity also extends under a portion of the bristles 112 of the brush head 108. The hollow, interior cavity is designed to retain an amount of dentifrice, such as toothpaste, tooth gel, or other similar liqui-plastic substances as is known in the art, without affecting the overall concept of the invention. The toothpaste is discharged from the hollow, interior cavity through an opening 304 in the brush head 108. The brush head 108 is in fluid communication with the hollow, interior cavity of the handle 102.

Further, the flossing device 116 comprises a first end 118 and a second end 120, wherein the flossing device 116 comprises a predetermined amount of floss 122 attached to the first end 118 and the second end 120 of the flossing device 116 to provide a taunt, horizontal string for flossing. The multiple use toothbrush device 300 also comprises a coil of floss (not shown) in the center of the handle 102 that users can use to pull out a desired amount of dental floss to replace the predetermined amount of floss 122 attached to the first end 118 and the second end 120 of the flossing device 116. Once a user uses a portion of the toothpaste in the cavity and/or the predetermined amount of floss 122, the multiple use toothbrush device 300 can be re-used. A user can dispense more toothpaste from the cavity, as needed and can dispense additional amounts of floss for the flossing device 116, as needed. Furthermore, both the toothpaste and the floss can be refilled when empty.

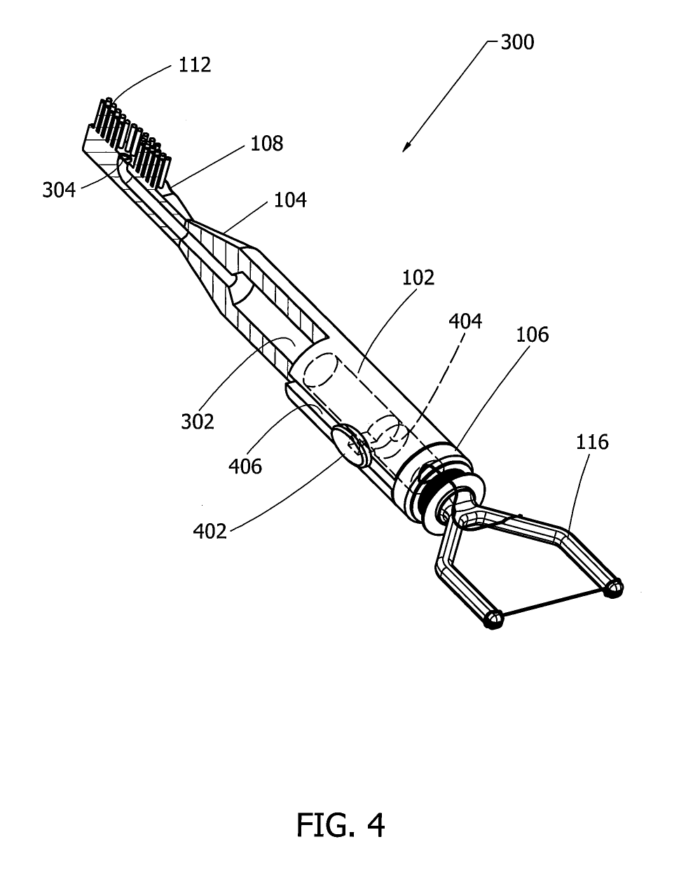

FIG. 4 illustrates a cut away of the handle 102 of the multiple use toothbrush device 300. The handle 102 comprises a hollow, interior cavity 302 comprising a predetermined amount of toothpaste (not shown). The hollow, interior cavity 302 extends along a longitudinal axis and extends from the first end 104 of the handle 102 to the second end 106 of the handle 102. The hollow, interior cavity 302 also extends under a portion of the bristles 112 of the brush head 108. The hollow, interior cavity 302 is designed to retain an amount of dentifrice, such as toothpaste, tooth gel, or other similar liqui-plastic substances as is known in the art, without affecting the overall concept of the invention. The toothpaste is discharged from the hollow, interior cavity 302 through an opening 304 in the brush head 108. Typically, the opening 304 is a flexible, plastic, X-shaped opening for discharging toothpaste, but can be any suitable shape and structure as is known in the art without affecting the overall concept of the invention. Further, the brush head 108 is in fluid communication with the hollow, interior cavity 302 of the handle 102.

Furthermore, an opening (not shown) is positioned adjacent to the second end 106 of the handle 102 for enabling a user to fill the interior cavity 302 with the desired toothpaste. Typically, a user would twist off the second end 106 to reveal the opening. However, any other suitable means for removably securing the second end 106 to the handle 102 can be used as is known in the prior art without affecting the overall concept of the invention. An actuator 402 is positioned on the handle 102, adjacent to the second end 106 of the handle 102 for controlling the flow of toothpaste from the hollow, interior cavity 302 to the brush head 108. The actuator 402 is typically a clicker, a button, a switch, etc., or any other suitable trigger as is known in the art without affecting the overall concept of the invention. The actuator 402 also comprises a flat end 404 which aids in moving the toothpaste forward. A user typically depresses the actuator 402 which causes the actuator 402 and the flat end 404 to move forward, pushing the toothpaste from the hollow, interior cavity 302 toward the brush head 108, wherein the toothpaste is dispensed from an opening 304 in the brush head 108. The actuator 402 is aligned with a track 406 that acts to move the actuator 402 and the flat end 404 forward a specified distance. Continual pushing would move the actuator 402 and the flat end 404 a further specified distance, such that the actuator 402 and the flat end 404 move in increments, dispensing an amount of toothpaste at each increment. If the brush head 108 and/or interior cavity 302 is clogged, a user removes the second end 106 and fills the opening with water to remove the clog.

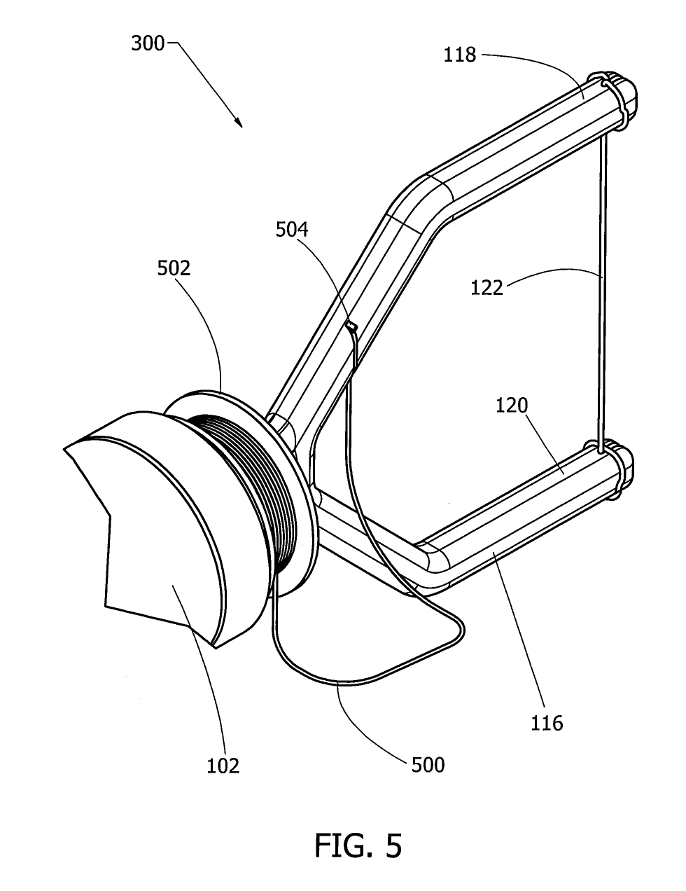

FIG. 5 illustrates the flossing device 116 of the multiple use toothbrush device 300. The flossing device 116 comprises a first end 118 and a second end 120, wherein the flossing device 116 comprises a predetermined amount of floss 122 attached to the first end 118 and the second end 120 of the flossing device 116 to provide a taunt, horizontal string for flossing. The multiple use toothbrush device 300 comprises a coil of floss 500 in the center of the handle 102 that users can use to pull out a desired amount of dental floss to replace the predetermined amount of floss 122 attached to the first end 118 and the second end 120 of the flossing device 116. The flossing device 116 also comprises a fixed spindle 502 for receiving the coil of floss 500 and a floss cutoff means 504. The coil of floss 500 is positioned on the fixed spindle 502 which is secured to the flossing device 116.

To dispense the floss, a user pulls a predetermined length of floss from the coil of floss 500 and secures the floss to the first end 118 and the second end 120 of the flossing device via wrapping the floss around a notched end of each of the first and second ends (118 and 120) and securing it. The floss can also be attached to the flossing device by any other suitable attaching means as is known in the art without affecting the overall concept of the invention. Once the floss is attached to the flossing device 116, the floss cutoff means 504 is used to cut the floss string. The floss cutoff means 504 can be a simple metal blade or any other cutting means as is known in the art without affecting the overall concept of the invention. Once a user uses the predetermined amount of floss 122, a user can dispense additional amounts of floss from the coil of floss 500 for the flossing device 116, as needed.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A toothbrush device, comprising:
a handle comprising a first end and a second end;
a brush head secured to the first end of the handle;
a flossing device secured to the second end of the handle; and
wherein the brush head is capable of dispensing a predetermined amount of toothpaste.

2. The toothbrush device of claim 1, wherein the toothbrush is a single use toothbrush and comprises a predetermined amount of toothpaste in center of the brush head.

3. The toothbrush device of claim 2, wherein the flossing device comprises a predetermined amount of dental floss attached to the flossing device.

4. The toothbrush device of claim 1, wherein the handle further comprises an interior cavity comprising toothpaste.

5. The toothbrush device of claim 4, wherein the interior cavity extends along a longitudinal axis from the first end of the handle to the second end of the handle.

6. The toothbrush device of claim 5, further comprising an actuator positioned on the handle for controlling the flow of the toothpaste from the interior cavity through the at least one opening in the brush head.

7. The toothbrush device of claim 6, wherein the actuator comprises at least one of a clicker, a button, or a switch.

8. The toothbrush device of claim 7, wherein the brush head comprises a plurality of bristles mounted on and extending outwardly from the brush head.

9. The toothbrush device of claim 8, wherein the interior cavity is in fluid communication with the at least one opening in the brush head.

10. The toothbrush device of claim 9, wherein the second end of the handle is removably attached to the handle to allow a user to fill the interior cavity with toothpaste.

11. The toothbrush device of claim 1, wherein the flossing device secured to the second end of the handle comprises a fixed spindle for receiving a coil of dental floss.

12. The toothbrush device of claim 11, wherein the flossing device further comprises a dental floss cutoff means.

13. The toothbrush device of claim 12, wherein the dental floss can be removably attached to the flossing device.

14. A toothbrush device, comprising:
a handle comprising a first end and a second end and an interior cavity;
a brush head secured to at least one of the first end or the second end of the handle;
a flossing device secured to at least one of the first end or the second end of the handle; and
wherein the interior cavity comprises toothpaste for dispensing through an opening in the brush head.

15. The toothbrush device of claim 14, wherein the second end of the handle is removably attached to the handle to allow a user to fill the interior cavity with toothpaste.

16. The toothbrush device of claim 15, further comprising an actuator positioned on the handle for controlling the flow of toothpaste from the interior cavity through the opening in the brush head.

17. The toothbrush device of claim 14, wherein the flossing device further comprises a fixed spindle for receiving a coil of dental floss.

18. The toothbrush device of claim 17, wherein the flossing device further comprises a floss cutoff means.

19. A single use toothbrush device, comprising:
a handle comprising a first end and a second end;
a brush head comprising bristles mounted on the brush head, wherein the brush head is secured to the first end of the handle; and
a flossing device comprising a first end and a second end, wherein the flossing device is secured to the second end of the handle; and
wherein the brush head comprises a predetermined amount of toothpaste between the bristles.

20. The single use toothbrush device of claim 19, wherein the flossing device comprises a predetermined amount of floss attached to the first end and the second end of the flossing device.
